(19) United States
(12) Patent Application Publication
(10) Pub. No.: US 2007/0029359 A1
(43) Pub. Date: Feb. 8, 2007

(54) Device for supporting objects on a steering wheel

(76) Inventor: Jon C. Smith, Falls Church, VA (US)

Correspondence Address: KRAMER & AMADO, P.C., 1725 DUKE STREET, SUITE 240, ALEXANDRIA, VA, 22314, US

(21) Appl. No.: 11/198,857

(22) Filed: Aug. 8, 2005

(51) Int. Cl. B60R 7/00

(52) U.S. Cl. 224/276

(57) ABSTRACT

A device for supporting objects on a steering wheel, in particular a device for supporting a cell phone on a steering wheel. The device has at least one central member, at least one gripping means, and at least one attachment area capable of supporting the object. The device may include adjustment means capable of varying the length of the central member and the pressure exerted by the gripping means inward on the steering wheel. The device may include at least one support arm and be located outward of the steering wheel's inner hub when secured to the steering wheel.

### FIELD OF THE INVENTION

This invention relates to a device for supporting objects on a steering wheel, in particular a device for supporting a cell phone on a steering wheel. This invention also relates to a device for supporting objects on a steering wheel for improved safety and use when the steering wheel is manipulated.

### BACKGROUND OF THE INVENTION

Certain objects, such as notepads, maps and cell phones, are commonly used within a vehicle, whether during longer trips or on a day-to-day basis. However, the layout of many vehicles, in particular automobiles, is rarely conducive to the use of such objects. Typically, vehicle interiors lack any space in which the object may be placed for easy access. Moreover, the use of such objects is often hindered, since the occupant must often simultaneously operate the vehicle.

Accordingly, objects may be more easily used when they are somehow supported within or on a vehicle, for example within a vehicle interior. Certain objects have been supported on the steering wheel of a vehicle for improved access. Such arrangements are considered to support the object closer to the occupant for ease of use. For example, map and notepad holders for attachment to a steering wheel are found in U.S. Pat. Nos. 5,056,822 and 5,193,777. Clipboard attachments for a steering wheel are found in U.S. Pat. Nos. 2,150,709 and 5,385,283. Even cigarette cases and computers have been attached to vehicle steering wheels as disclosed in U.S. Pat. Nos. 2,514,102 and 5,542,314, respectively.

Nevertheless, various deficiencies exist with current devices found in the art. For instance, many devices are difficult to install and use, and are commonly made to support one particular object, such as a notepad or cigarette case. Also, when used in an automobile, the devices often block the deployment of any steering wheel located airbag, thereby reducing vehicle safety. Moreover, no steering wheel support devices of the art allow for the simultaneous and continuous use of an object when the steering wheel is manipulated, such as when the vehicle is in motion. In particular, no device discloses supporting a cell phone on a vehicle's steering wheel, wherein the cell phone may be easily and continuously used by the occupant when operating the vehicle. Accordingly, these and other deficiencies may be addressed by the present invention.

### SUMMARY OF THE INVENTION

The present invention relates to improved devices for supporting objects on a steering wheel. The present invention in particular relates to devices for supporting a cell phone on a steering wheel, for improved installation, safety and ease of use.

In a preferred embodiment, the present invention relates to a device for supporting objects on a steering wheel, the device comprising at least one central member; at least one gripping means connected to the central member, wherein the gripping means is capable of receiving the steering wheel; adjustment means capable of varying the pressure exerted by the gripping means inward on the steering wheel; and at least one attachment area capable of supporting said object.

In another preferred embodiment, the present invention relates to a device for supporting objects on a steering wheel, the device comprising at least one central member; at least one gripping means connected to the central member, wherein the gripping means has an inward facing, concave end for receiving an outer rim of the steering wheel; adjustment means capable of varying the length of the central member and pressure exerted by the concave end inward on the steering wheel; and at least one attachment area capable of supporting the object.

In a further preferred embodiment, the present invention relates to a device for supporting objects on a steering wheel, the device comprising at least one central member; at least one attachment area capable of supporting the object; at least one support arm connected to the central member; gripping means connected to the support arm, wherein the gripping means is capable of receiving the steering wheel; wherein the steering wheel has an inner hub, the device located outward of the inner hub when secured to the steering wheel.

### BRIEF DESCRIPTION OF THE DRAWINGS

FIG. 1 is a front view of a preferred embodiment of the present invention supporting a cell phone.

FIG. 2 is side view of a holding flange for use with preferred embodiments of the present invention.

FIG. 3 is a side view of a preferred embodiment of the present invention supporting a cell phone.

FIG. 4 is a rear view of the FIG. 3 preferred embodiment of the present invention.

FIG. 5 is a front view of the FIG. 3 preferred embodiment of the present invention.

FIG. 6 is a front view of adjustment means for use with preferred embodiments of the present invention.

### DETAILED DESCRIPTION OF PREFERRED EMBODIMENTS

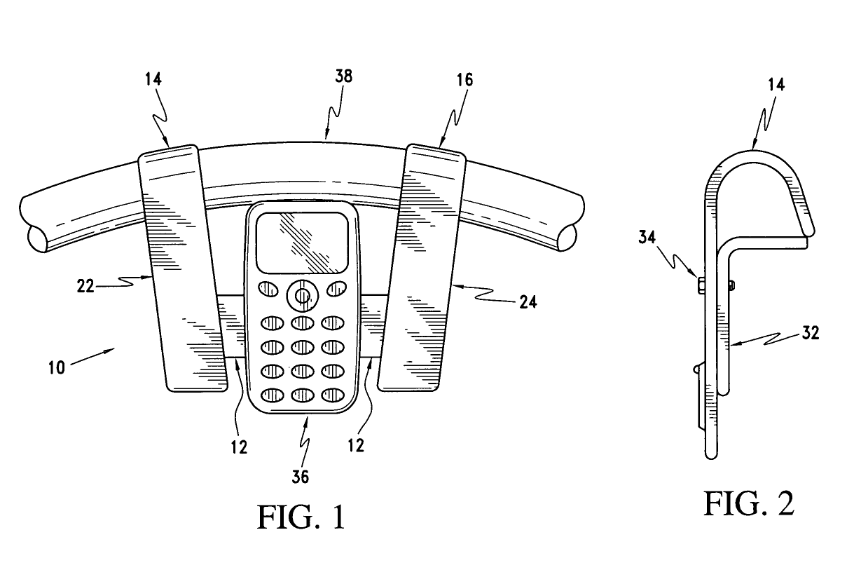

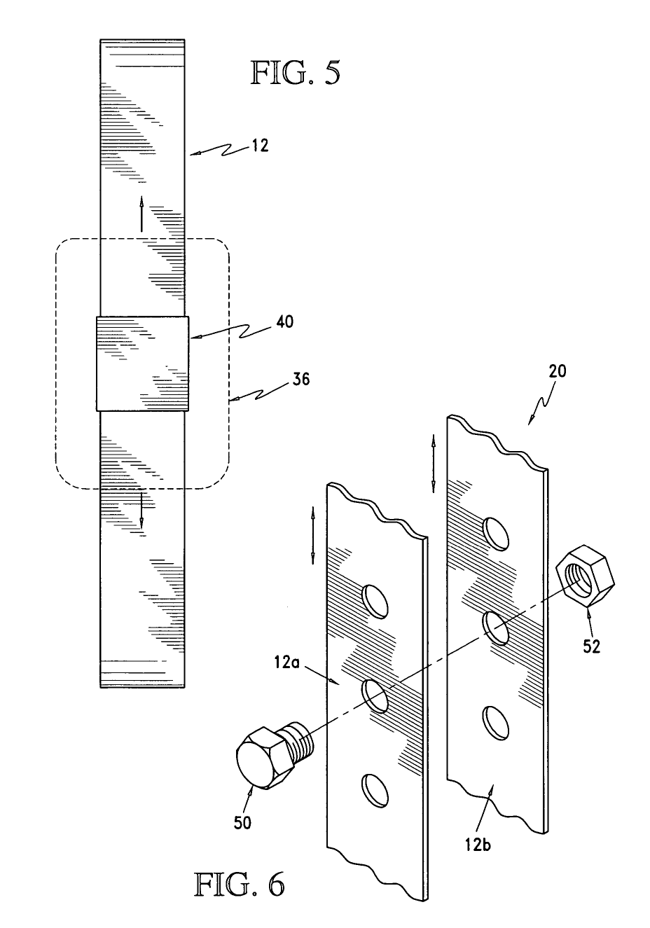

With reference to the drawings, in particular FIGS. 1-5, the present invention may be described in preferred embodiments as a device 10 for supporting objects 36 on a steering wheel 38. The device 10 generally comprises a central member 12, gripping means 14, 16, and an attachment area 18. The device 10 may also comprise attachment means 26 and/or adjustment means 20. In preferred embodiments, the device 10 may comprise at least one support arm 22, 24.

With reference to FIG. 1, a preferred embodiment of device 10 comprises at least one central member 12; at least one attachment area 18 capable of supporting the object 36; at least one support arm 22, 24 connected to the central member 12; gripping means 14, 16 connected to the support arm 22, 24, wherein the gripping means 14, 16 is capable of receiving the steering wheel 38; wherein the steering wheel 38 has an inner hub, the device 10 located outward of the inner hub when secured to the steering wheel 38.

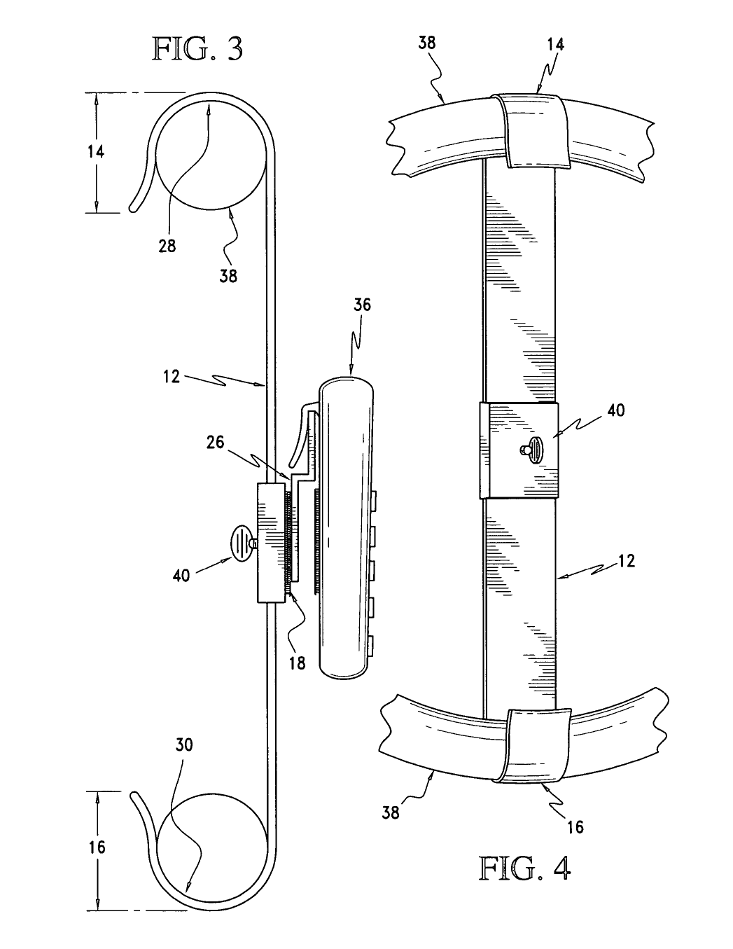

With reference to FIGS. 3-5, another preferred embodiment of device 10 comprises at least one central member 12; at least one gripping means 14, 16 connected to the central member 12, wherein the gripping means 14, 16 is capable of receiving the steering wheel 38; adjustment means 20 capable of varying the pressure exerted by the gripping means 14, 16 inward on the steering wheel 38; and at least one attachment area 18 capable of supporting the object 36.

Again with reference to FIGS. 3-5, a further preferred embodiment of device 10 comprises at least one central member 12; at least one gripping means 14, 16 connected to the central member 12, wherein the gripping means 14, 16 has an inward facing, concave end 28, 30 for receiving an outer rim of the steering wheel 38; adjustment means 20 capable of varying the length of the central member 12 and pressure exerted by the concave end 28, 30 inward on the steering wheel 38; at least one attachment area 18 capable of supporting said object 36.

The gripping means 14, 16 of the present invention may include a variety of means, in particular means capable of gripping the rim of a steering wheel 38. Such gripping means 14, 16 suitable for use in the present invention may include a variety of mechanisms, for example clamps, flanges, and even inward or outward facing, concave ends capable of receiving the rim of the steering wheel, as would be recognized by one of ordinary skill in the art. The gripping means 14 may be made of a flexible material, to assist, for example, in gripping rims of varying size. In preferred embodiments, the gripping means 14, 16 is capable of receiving the outer rim of the steering wheel 38. Preferably, the gripping means 14, 16 includes an inward facing, concave end 28, 30 for receiving the outer rim of the steering wheel 38. Moreover, the inner rim 38 of the steering wheel preferably remains exposed once the outer rim is received by concave end 28, 30. Nevertheless, in preferred embodiments, the gripping means 14, 16 may include a holding flange 32, for securing the gripping means 14, 16 to the steering wheel 38. As shown in FIG. 2, the holding flange 32 may include an adjusting nut 34 for securing the gripping means 14, 16 to the steering wheel 38. In preferred embodiments, the gripping means 14, 16 may be integrally connected to the central member 12, for example as shown in FIGS. 3-4.

The present invention may also include adjustment means 20, preferably adjustment means 20 capable of varying the length of the central member 12. If so desired, the adjustment means 20 may work in a manner that the length of the central member 12 is varied by extending and/or retracting the central member 12, or sections of the central member 12, in a telescopic manner. It will be recognized that the adjustment means 20 may be located within or without the central member 12, and may include a variety of means, for example telescoping or spring-loaded mechanisms as well as nut and bolt arrangements. For example, with reference to FIG. 6, one of ordinary skill in the art will recognize that, in one embodiment, the adjustment means 20 may constitute a central member 12 made up of two sections (12a, 12b) fitted with openings, wherein each section (12a, 12b) may be moved longitudinally with respect to the other, in order to vary the overall length of the central member 12, wherein a bolt 50 may be inserted through an opening of each section (12a, 12b) and then fitted with a nut 52, so as to fix the length of the central member 12. In preferred embodiments, the adjustment means 20 is capable of varying the pressure exerted by the concave end 28, 30 of the gripping means 14, 16 inward on the steering wheel 38. It will be recognized that where the gripping means 14, 16 receives the outer rim of the steering wheel 38, and the gripping means 14, 16 is connected to the central member 12, reducing the length of the central member 12 may be used to increase the pressure exerted by the gripping means 14, 16 inward on the steering wheel 38.

The present invention may include at least one attachment area 18 capable of supporting an object 36, for instance supporting a cell phone on or along the central member 12. In preferred embodiments, the attachment area 18 may be on or part of the central member 12. In other preferred embodiments, the attachment area 18 may be located along the central member 12. For example, as shown in FIGS. 3-4, the attachment area 18 may be located on a sleeve 40 that surrounds the central member 12. If so desired, the attachment area 18 may be slidable along the central member 12, for example as the slidable sleeve 40 of FIGS. 3-4, so that the location of the attachment area 18 may be varied along the central member 12.

The attachment area 18 preferably includes attachment means 26 capable of supporting the object 36. As shown in FIG. 3, attachment means 26 preferably comprise an adapter that is capable of both supporting an object 36 (e.g., a cell phone) and being fastened to the attachment area 18. By way of example only, both the adapter and attachment area 18 may be fitted with VELCRO®, as shown in FIG. 3, so that the VELCRO® may be used to fasten the adapter to the attachment area 18. However, one of ordinary skill in the art will recognize that a variety of mechanisms may be suitable as attachment means 26 in the context of the present invention, for example a pocket for receiving an object 36, an adapter for supporting the clip adapter of an object 36 (e.g., cell phone), VELCRO®, as well as fasteners of various type (e.g., nut and bolt). Indeed, it will be recognized that attachment means 26 preferably includes any mechanism capable of attaching the object 36 to the device 10, in particular attaching the object 36 to the attachment area 18.

It should be recognized that device 10 of the present invention may be used to support a variety of objects 36 on a steering wheel 38. Such objects 36 may include, by way of example only, notepads, maps and cell phones, as would be recognized by one of ordinary skill in the art. Nevertheless, the device 10 is considered to be especially advantageous in supporting a cell phone on a steering wheel 38, at the very least in that cell phones are one of the most commonly used items, within and without vehicles. Moreover, many cell phones today are voice activated, so that in using the cell phone, the user need not manipulate the cell phone by hand. Accordingly, once a cell phone is supported on a steering wheel with the device 10, a vehicle occupant may concentrate on operating the vehicle, often with no need to manipulate the cell phone by hand.

In addition, it is pointed out that in preferred embodiments of the present invention, the object 36 (e.g., cell phone, notepad, maps) may be rotationally supported on the steering wheel 38, so that the object 36 remains in an about upright position when the steering wheel 38 is manipulated. It will be recognized that in this aspect of the invention, since objects 36 are maintained in an upright position, the objects 36 may be more easily used, perhaps continuously, during operation of the vehicle, even when the steering wheel 38 is rotated. Preferably, the object 36 is rotationally supported on the attachment area 18 and/or by attachment means 26. For example, with reference to FIG. 3, the attachment means 26 may be attached to the attachment area 18 by a swivel mechanism (not shown) capable of rotation, clockwise and/or counterclockwise, in the same plane as the steering wheel 38. In such example, when the steering wheel 38 is rotated by the vehicle occupant, the attachment means 26 supporting the object 36 may rotate in a direction opposite of the steering wheel 38, so that the object 36 remains in an about upright position. As another example, the object 36 may be attached to the attachment means 26 by a swivel mechanism (not shown) capable of rotation, clockwise and/or counterclockwise, in the same plane as the steering wheel 38. In such example, when the steering wheel 38 (and attachment means 26) is rotated by the vehicle occupant, the object 36 may rotate in a direction opposite of the steering wheel 38 (and attachment means 26), so that the object 36 remains in an about upright position. It is noted that a variety of mechanisms may be used to rotationally support the object 36 on a steering wheel 38, for example a swivel or other mechanism capable of rotation. It should also be recognized that the object 36 need not be maintained in an entirely upright position at all times, so that some rotation of the object 36 about a normally upright position is permissible.

Again referencing FIG. 1, it will be recognized that in preferred embodiments, the present invention may include at least one support arm 22, 24. Preferably, the support arm 22, 24 is connected to the central member 12, and may be integrally connected to the central member 12. It is preferred that the support arm 22, 24 is connected to the central member 12 at an angle of 45 to 90 degrees. Moreover, in preferred embodiments at least one gripping means 14, 16 is connected to the support arm 22, 24, and may be integrally connected to the support arm 22, 24.

With further reference to FIG. 1, it is recognized that a variety of vehicles include a steering wheel 38 having an inner hub (not shown), a rim, and various forms of spokes attaching the inner hub to the rim. It is noted that the inner hub of such a steering wheel 38 often contains an airbag for deployment during collisions and other accidents involving the vehicle. Accordingly, in preferred embodiments of the present invention, where the steering wheel 38 has an inner hub, the device 10 may be located outward of the inner hub when secured to the steering wheel 38, as will be recognized upon viewing FIG. 1. In addition to providing for improved vehicle safety, by not interfering with airbag deployment, and ease of attachment of device 10 to the steering wheel 38, this aspect of the present invention may provide for improved viewing of vehicle instruments and controls.

While there has been disclosed herein what is considered to be certain preferred embodiments of the present invention, it will be understood by those of ordinary skill in the art that various changes and modifications may be made therein without departing from the scope of the appended claims.

Accordingly, the foregoing disclosure is neither intended, nor to be construed to limit the present invention or otherwise exclude any such other embodiments, adaptations, variations, modifications and equivalent arrangements.

The disclosure of all references cited herein are hereby incorporated by reference in their entirety.

What is claimed is:

1. A device for supporting objects on a steering wheel, said device comprising:
at least one central member;
at least one gripping means connected to the central member, wherein the gripping means is capable of receiving said steering wheel;
adjustment means capable of varying the pressure exerted by the gripping means inward on said steering wheel;
at least one attachment area capable of supporting said object.

2. The device of claim 1, wherein the gripping means is integrally connected to the central member.

3. The device of claim 1, wherein the gripping means includes an inward facing, concave end for receiving an outer rim of said steering wheel.

4. The device of claim 3, wherein an inner rim of said steering wheel remains exposed once the outer rim is received by the inward facing concave end.

5. The device of claim 1, wherein the adjustment means is capable of varying the length of the central member.

6. The device of claim 5, wherein the adjustment means is capable of telescopically varying the length of the central member.

7. The device of claim 1, wherein the attachment area is located on or along the central member.

8. The device of claim 1, wherein the attachment area includes attachment means for supporting said object.

9. The device of claim 1, wherein said object is rotationally supported, so that said object remains in an about upright position when the steering wheel is manipulated.

10. A device for supporting objects on a steering wheel, said device comprising:
at least one central member;
at least one gripping means connected to the central member, wherein the gripping means has an inward facing, concave end for receiving an outer rim of said steering wheel;
adjustment means capable of varying the length of the central member and pressure exerted by the concave end inward on said steering wheel;
at least one attachment area capable of supporting said object.

11. The device of claim 10, wherein the gripping means is integrally connected to the central member.

12. The device of claim 10, wherein an inner rim of said steering wheel remains exposed once the outer rim is received by the inward facing concave end.

13. The device of claim 10, wherein the adjustment means is capable of telescopically varying the length of the central member.

14. The device of claim 10, wherein the attachment area is located on or along the central member.

15. The device of claim 10, wherein the attachment area includes attachment means for supporting said object.

16. The device of claim 10, wherein said object is rotationally supported, so that said object remains in an about upright position when the steering wheel is manipulated.

17. A device for supporting objects on a steering wheel, said device comprising:
at least one central member;
at least one attachment area capable of supporting said object;
at least one support arm connected to the central member;
gripping means connected to the support arm, wherein the gripping means is capable of receiving said steering wheel;
wherein said steering wheel has an inner hub, said device located outward of the inner hub when secured to said steering wheel.

18. The device of claim 17, wherein the gripping means includes an inward facing, concave end for receiving an outer rim of said steering wheel.

19. The device of claim 18, wherein an inner rim of said steering wheel remains exposed once the outer rim is received by the inward facing concave end.

20. The device of claim 17, wherein the gripping means includes a holding flange for securing the gripping means to said steering wheel.

21. The device of claim 17, wherein the support arm is connected to the central member at an angle of 45 to 90 degrees.

22. The device of claim 17, wherein the support arm is integrally connected to the central member.

23. The device of claim 17, wherein the gripping means is integrally connected to the support arm.

24. The device of claim 17, wherein the attachment area is located on or along the central member.

25. The device of claim 17, wherein the attachment area includes attachment means for supporting said object.

26. The device of claim 17, wherein said object is rotationally supported, so that said object remains in an about upright position when the steering wheel is manipulated.
